(19) United States
(12) Patent Application Publication
(10) Pub. No.: US 2024/0357425 A1
(43) Pub. Date: Oct. 24, 2024

(54) INFORMATION PROCESSING APPARATUS, INFORMATION PROCESSING METHOD, AND INFORMATION PROCESSING SYSTEM

(71) Applicant: SONY GROUP CORPORATION, TOKYO (JP)

(72) Inventors: AYUMI KOBAYASHI, TOKYO (JP); NATSUKI ITAYA, TOKYO (JP); KAZUYUKI SHIMEZAWA, TOKYO (JP); MITSURU KATSUMATA, TOKYO (JP); KENTA ABE, TOKYO (JP)

(21) Appl. No.: 18/684,888

(22) PCT Filed: Mar. 7, 2022
(86) PCT No.: PCT/JP2022/009628

§ 371 Date: Feb. 20, 2024

(30) Foreign Application Priority Data
Sep. 6, 2021 (JP) 2021-144465

(51) Int. Cl. H04W 28/08; H04W 28/20; H04W 72/30

(52) U.S. Cl. CPC H04W 28/0925; H04W 28/20; H04W 72/30

(57) ABSTRACT

An information processing apparatus (100) includes a control unit (130). The control unit (130) requests a cellular communication system (30) to activate a communication line used by a plurality of terminal devices (40) that are service providing targets. The control unit (130) assigns the plurality of terminal devices (40) to at least one group according to a service provided. When the service is started to be provided to the plurality of terminal devices (40) corresponding to the one group, the control unit (130) determines a resource to be allocated to the plurality of terminal devices (40) corresponding to the one group. The control unit (130) requests the cellular communication system (30) to secure the resource.

### FIELD

The present disclosure relates to an information processing apparatus, an information processing method, and an information processing system.

### BACKGROUND

Conventionally, when a user connects to a cellular communication system using a terminal device, an available data communication amount (packet amount) may be limited in advance by a contract. When the available packet amount is exceeded, an additional fee is charged or a transmission rate is limited.

In addition, there is known a system in which a terminal device performs communication within a range of a communication amount according to a paid fee, such as a prepaid system. In this system, for example, there is a technology of managing a remaining communication amount of the terminal device for each connection destination when the terminal device is connected to a communication network. In this technology, the terminal device acquires information on the connection destination whose communication amount remains, and connects to the connection destination with remaining communication amount to perform communication.

### CITATION LIST

### Patent Literature

Patent Literature 1: JP 2012-138709 A

### SUMMARY

### Technical Problem

With the development of cellular communication technologies, various services provided via cellular communication lines have been proposed. For example, a system for providing a service via a cellular communication line to a user who has made a contract to receive the service by purchasing a ticket, such as live distribution, is conceivable.

In this system, when a packet amount that the user can use is limited, a transmission rate may be restricted during live distribution, or the distribution itself may be stopped. When the transmission rate is restricted or the service is stopped while the service is provided, user convenience is significantly degraded.

Therefore, the present disclosure provides a system capable of suppressing degradation of the user convenience while the service is provided.

Note that the above problem or object is merely one of a plurality of problems or objects that can be solved or achieved by a plurality of embodiments disclosed in the present specification.

### Solution to Problem

According to the present disclosure, an information processing apparatus is provided. The information processing apparatus includes a control unit. The control unit requests a cellular communication system to activate a communication line used by a plurality of terminal devices that are service providing targets. The control unit assigns the plurality of terminal devices to at least one group according to a service provided. When the service is started to be provided to the plurality of terminal devices corresponding to the one group, the control unit determines a resource to be allocated to the plurality of terminal devices corresponding to the one group. The control unit requests the cellular communication system to secure the resource.

### BRIEF DESCRIPTION OF DRAWINGS

FIG. 1 is a diagram illustrating an outline of a proposed technology of the present disclosure.

FIG. 2 is a block diagram illustrating a configuration example of an information processing apparatus according to an embodiment of the present disclosure.

FIG. 3 is a diagram illustrating a configuration example of a table stored in a storage unit according to the embodiment of the present disclosure.

FIG. 4 is a table illustrating an example of a ticket information table according to the embodiment of the present disclosure.

FIG. 5 is a table illustrating an example of a line information table according to the embodiment of the present disclosure.

FIG. 6 is a table illustrating an example of a share group information table according to the embodiment of the present disclosure.

FIG. 7 is a table illustrating an example of a service information table according to the embodiment of the present disclosure.

FIG. 8 is a diagram illustrating an example of an architecture of a cellular communication system according to the embodiment of the present disclosure.

FIG. 9 is a block diagram illustrating a configuration example of a server device according to the embodiment of the present disclosure.

FIG. 10 is a block diagram illustrating a configuration example of a terminal device according to the embodiment of the

FIG. 11 is a sequence diagram illustrating an example of a flow of a line activating process according to the embodiment of the present disclosure.

FIG. 12 is a sequence diagram illustrating an example of a flow of a service providing process according to the embodiment of the present disclosure.

FIG. 13 is a flowchart illustrating an example of a flow of a QoS control process according to the embodiment of the present disclosure.

FIG. 14 is a sequence diagram illustrating an example of a flow of a line activating process according to a modification of the embodiment of the present disclosure.

### DESCRIPTION OF EMBODIMENTS

Hereinafter, an embodiment of the present disclosure will be described in detail with reference to the accompanying drawings. Note that, in the present specification and the drawings, components having substantially the same functional configuration are denoted by the same reference signs to omit redundant description.

In the present specification and the drawings, similar components in the embodiment may be distinguished by adding a different alphabet or number after the same reference sign. However, when it is not necessary to particularly distinguish each of similar components, only the same reference sign is assigned.

Furthermore, in the present specification and the drawings, specific values may be indicated and described, but the values are merely examples, and other values may be applied.

In the description below, one or more embodiments (including examples and modifications) can be implemented independently. On the other hand, at least some of the plurality of embodiments described below may be appropriately combined with at least some of other embodiments. The plurality of embodiments may include novel features different from each other. Therefore, the plurality of embodiments can contribute to solving different objects or problems, and can exhibit different effects.

### 1. Outline of Proposed Technology

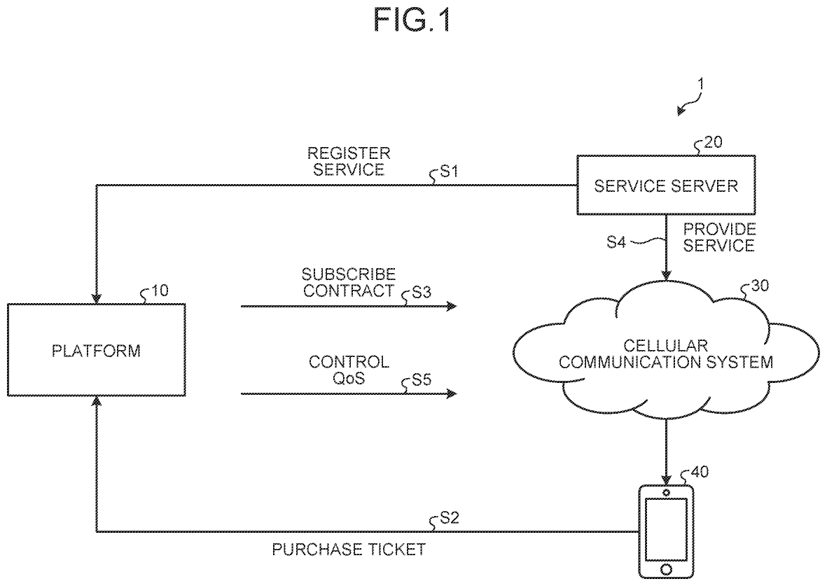

First, an outline of a proposed technology according to the present disclosure will be described. FIG. 1 is a diagram illustrating the outline of the proposed technology of the present disclosure. The proposed technology according to the present disclosure is implemented in an information processing system 1 illustrated in FIG. 1. As illustrated in FIG. 1, the information processing system 1 includes a platform 10, a service server 20, a cellular communication system 30, and a terminal device 40.

The service server 20 is, for example, an information processing apparatus that performs a live distribution service. The service server 20 provides a service to the terminal device 40 by transmitting a live video to the terminal device 40 via the cellular communication system 30.

The cellular communication system 30 is, for example, a cellular wireless or wired network and a node that constructs the network defined by the 3rd Generation Partnership Project (3GPP). The cellular communication system 30 is, for example, a communication system using a radio access technology (RAT) such as long term evolution (LTE) or new radio (NR). Here, a radio access network may be an evolved universal terrestrial radio access network (E-UTRAN) or a next generation radio access network (NG-RAN).

The cellular communication system 30 provides, for example, a communication path to the service server 20, regardless of the Internet or a closed network, to the terminal device 40 used by a service user (hereinafter also referred to as a user).

When the user concludes a contract to receive the service provided by the service server 20, such as purchasing a live ticket, the terminal device 40 is connected to the cellular communication system 30 to enjoy the service from the service server 20.

Note that, in the information processing system 1 of the present disclosure, the contract for receiving the service includes a contract for activating a line in the cellular communication system 30 for receiving the service. In other words, while receiving the service (e.g., during live distribution), the user enjoys the service by using the line activated between the user and the cellular communication system 30. On the other hand, when the service is not provided such as before the start of the service or after the end of the service (e.g., before the start of live distribution or after the end of distribution), the user cannot use the line.

As described above, in the information processing system 1 of the present disclosure, the service server 20 provides the service to the terminal device 40 for a predetermined period using the line of the cellular communication system 30 activated for providing the service.

Here, the platform 10 makes a contract for providing the service (e.g., selling a ticket) on behalf of the service server 20. In addition, the platform 10 makes a contract and the like for activating the line of the cellular communication system 30 on behalf of the user who has made the contract for receiving the service (e.g. purchasing a ticket).

For example, in FIG. 1, when the platform 10 receives service registration, such as live distribution, from the service server 20 (Step S1), the platform 10 sells a ticket related to the service. For example, the user purchases the ticket from the platform 10 via the terminal device 40 (Step S2).

Although one terminal device 40 purchases the ticket in FIG. 1, the number of terminal devices 40 that purchase a ticket may be one or more.

Then, the platform 10 performs, on behalf of the user, a subscription contract of the line with a business support system (BSS) (not illustrated) of the cellular communication system 30 (Step S3) to activate the line.

When the service start time comes, the service server 20 provides the service to the terminal device 40 using the line of the cellular communication system 30 (Step S4).

As described above, when the terminal device 40 is connected to the cellular communication system 30, an available data communication amount is often determined according to, for example, a fee (coupon fee). In this case, when the available data communication amount (packet amount) is exceeded, an excess bandwidth of the terminal device 40 is often suppressed to about several hundred kbps by a band control device (not illustrated) provided in the cellular communication system 30.

In the information processing system 1 illustrated in FIG. 1, when a so-called coupon shortage occurs and the available packet amount is exceeded while the service server 20 provides the service to the terminal device 40, the user cannot sufficiently enjoy the service. When an excess of the packet amount (coupon shortage) occurs while the service is provided, a quality of the service is deteriorated. As a result, user convenience degrades.

Therefore, it is desirable to perform a bandwidth control so that the packet amount does not exceed the upper limit while the service server 20 provides the service.

Here, in the cellular communication system 30, for example, the band control device controls the bandwidth based on the presence or absence of the excess of the packet amount (coupon shortage) and a packet priority.

For example, in recent years, an application programming interface (API) has been released from the cellular communication system 30 to a service provider (e.g., platform 10). The API allows service providers to utilize some of functionality of the cellular communication system 30, such as Quality of Service (QoS) control. In other words, the service provider can communicate with the band control device via the API.

However, from a viewpoint of a business model of the cellular communication system 30, it is difficult for the service provider to set a rule related to a billing plan of the cellular communication system 30 via the API. For example, it is not realistic for the service provider to set a rule (e.g., a new upper limit of the packet amount), via the API, that exceeds the upper limit of the packet amount set by the cellular communication system 30.

Therefore, in the information processing system 1 of the present disclosure, the platform 10 assign a plurality of terminal devices 40 to at least one group (share group to be described later) according to the service provided by the service server 20.

When the service will be provided to the plurality of terminal devices 40 corresponding to the group, the platform 10 determines a resource to be allocated to the plurality of terminal devices 40 corresponding to the group. The platform 10 performs a QoS control of a line used by the terminal devices 40 by requesting the cellular communication system 30 to secure the resource (Step S5 in FIG. 1).

For example, while providing the service, the platform 10 determines the resource to be allocated to the plurality of terminal devices 40 so that the packet amount does not exceed the upper limit. As a result, the platform 10 can perform the QoS control of the line used by the terminal devices 40 so that the terminal devices 40 do not cause coupon shortage while the service server 20 provides the service. In this manner, the platform 10 according to the present disclosure can suppress degradation of the user convenience while the service is provided.

For example, when the service provided by the service server 20 ends, the platform 10 cancels the line with respect to the cellular communication system 30. As a result, the terminal devices 40 cannot be connected to the cellular communication system 30.

As described above, in the information processing system 1 of the present disclosure, the platform 10 performs a proxy contract (contract conclusion and contract cancellation) with the cellular communication system 30 for the line of the terminal device 40 that has made a service contract such as by purchasing a ticket. As a result, the information processing system 1 can provide a service with a predetermined quality to the terminal device 40 using the line during a period in which the service server 20 provides the service.

Note that, the information processing system 1 in FIG. 1 illustrates a case where there is one service server 20, but the present disclosure is not limited thereto. There may be a plurality of service servers 20. In addition, FIG. 1 illustrates a case where the service server 20 provides one service, but the present disclosure is not limited thereto. The service server 20 may provide a plurality of services.

In addition, FIG. 1 illustrates a case where there is one cellular communication system 30, but the present disclosure is not limited thereto. There may be a plurality of cellular communication systems 30. For example, the information processing system 1 may include a plurality of cellular communication systems 30 operated and/or managed by different mobile network operators (MNOs). Furthermore, the service server 20 may provide one service to the terminal device 40 via the plurality of different cellular communication systems 30.

Furthermore, FIG. 1 illustrates a case where there is one terminal device 40, but the present disclosure is not limited thereto. There may be a plurality of terminal devices 40. In this case, the plurality of terminal devices 40 may be connected to different cellular communication systems 30. Further, the plurality of terminal devices 40 can receive different services from different service servers 20.

### 2. Configuration Example of Information Processing System

As illustrated in FIG. 1, the information processing system 1 according to the embodiment of the present disclosure includes the platform 10, the service server 20, the cellular communication system 30, and the terminal device 40. Each component will be described below.

### 2.1. Information Processing Apparatus

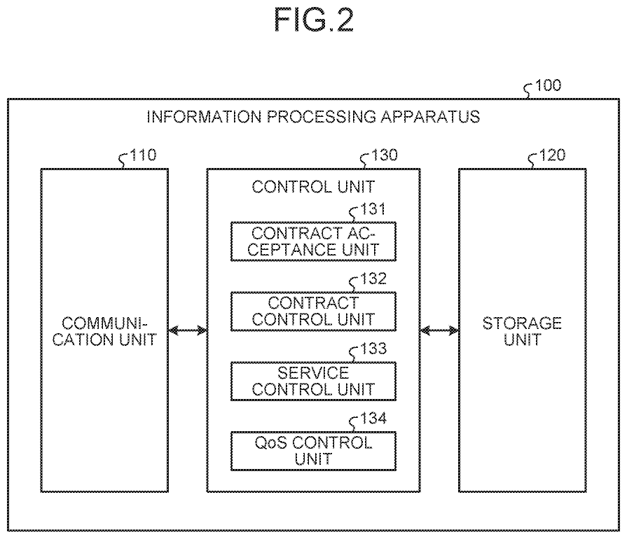

First, an information processing apparatus 100 will be described with reference to FIG. 2. FIG. 2 is a block diagram illustrating a configuration example of the information processing apparatus 100 according to the embodiment of the present disclosure. The information processing apparatus 100 is, for example, an apparatus that functions as the platform 10.

The information processing apparatus 100 illustrated in FIG. 2 includes a communication unit 110, a storage unit 120, and a control unit 130. Note that the configuration illustrated in FIG. 2 is a functional configuration, and a hardware configuration may be different from the functional configuration. Furthermore, the functions of the information processing apparatus 100 may be implemented in a distributed manner in a plurality of physically separated configurations. For example, the information processing apparatus 100 may include a plurality of server devices.

### [Communication Unit 110]

The communication unit 110 is a communication interface for communicating with other devices. The communication unit 110 may be a network interface or a device connection interface. For example, the communication unit 110 may be a local area network (LAN) interface such as a network interface card (NIC), or may be a USB interface including a universal serial bus (USB) host controller, a USB port, and the like. Furthermore, the communication unit 110 may be a wired interface or a wireless interface. The communication unit 110 functions as a communication means of the information processing apparatus 100. The communication unit 110 communicates with the service server 20, the cellular communication system 30, and the terminal device 40 under the control of the control unit 130.

[Storage unit 120]

The storage unit 120 is a data readable/writable storage device such as a dynamic random access memory (DRAM), a static random access memory (SRAM), a flash memory, or a hard disk. The storage unit 120 functions as a storage means of the information processing apparatus 100.

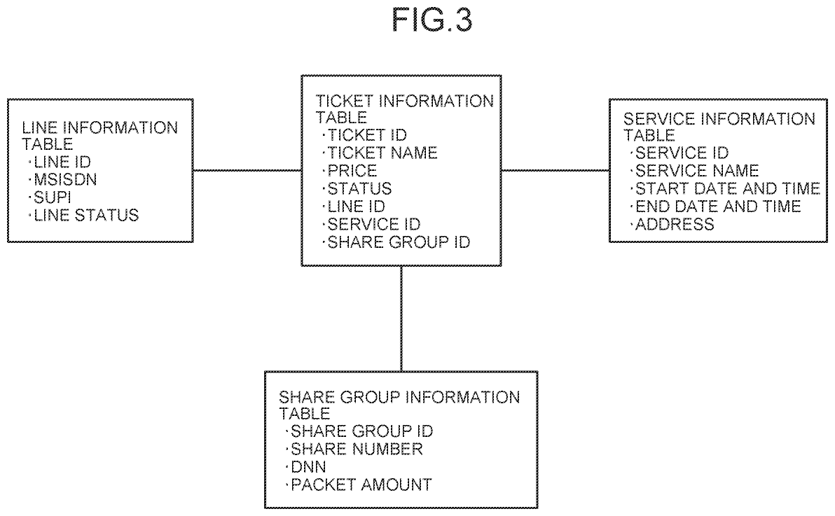

The storage unit 120 stores, for example, information for providing a service to the terminal device 40. FIG. 3 is a diagram illustrating a configuration example of a table stored in the storage unit 120 according to the embodiment of the

### (Ticket Information Table)

As illustrated in FIG. 3, the storage unit 120 stores ticket information regarding tickets to be sold in a ticket information table. The ticket information includes, for example, information on at least one of a ticket ID, a ticket name, a price, a status, a line ID, a service ID, and a share group ID.

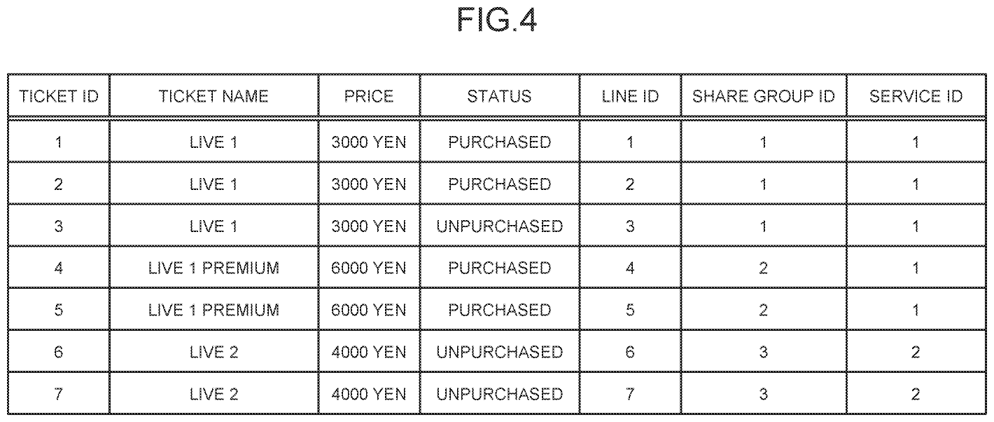

FIG. 4 is a table illustrating an example of the ticket information table according to the embodiment of the present disclosure. In the ticket information table illustrated in FIG. 4, information on the ticket ID, the ticket name, the price, the status, the line ID, the share group ID, and the service ID is managed.

In the “ticket ID”, identification information assigned to each ticket sold by the platform 10 to identify each ticket is stored. In the “ticket name”, name indicating a ticket type, such as “Live 1”, “Live 1 Premium”, and “Live 2” in the example in FIG. 4, is stored. In the “price”, a sales price of a ticket corresponding to the ticket type is stored. In the example in FIG. 4, “Live 1” is sold at “3000 yen” and “Live 1 Premium” is sold at “6000 yen”.

In the “status”, information on a sales status of the ticket is stored. For example, in FIG. 4, “purchased” or “unpurchased” of the ticket is stored in the “status”. In the “line ID”, identification information for identifying line information related to a line contract with the cellular communication system 30 is stored.

In the “share group ID”, identification information for identifying a share group is stored. The share group includes a plurality of terminal devices 40 whose lines are activated. The plurality of terminal devices 40 shares a predetermined data communication amount (e.g., packet amount) to receive the service. The “service ID” includes identification information for identifying the service provided by the service server 20.

As illustrated in FIG. 4, “Live 1” and “Live 1 Premium” have different names in the “ticket name”, but the “service ID” is the same “1”. In this manner, one service can be provided in different manners, for example, in different data communication amounts (e.g., “20 Gbyte” for “Live 1” and “40 Gbyte” for “Live 1 Premium”).

In FIG. 4, when the “ticket name” and the “share group ID” correspond to each other on a one-to-one basis. In other words, when names in the “ticket name” are the same, the “share group ID” is the same. However, the present disclosure is not limited thereto. For example, tickets having the same “ticket name” may be divided into a plurality of share groups. For example, when there are 50 tickets of which the “ticket name” is “live 1”, the tickets whose “ticket name” is “live 1” may be divided into two share groups of 25 tickets each (e.g., share groups whose “share group ID” is “1-1” and “1-2”)

Note that tickets having different names in the “ticket name” are not classified into the same share group. For example, it is assumed that a ticket whose “ticket name” is “Live 1” and a ticket whose “ticket name” is “Live 1 Premium” are not classified into the same share group (e.g., share group having the “share group ID” of “1”).

### (Line Information Table)

Description returns to FIG. 3. As illustrated in FIG. 3, the storage unit 120 stores the line information regarding the line of the cellular communication system 30 in a line information table. The line information includes, for example, at least one of a line ID, a mobile subscriber integrated services digital network number (MSISDN), a subscriber permanent identifier (SUPI), and information regarding a line status.

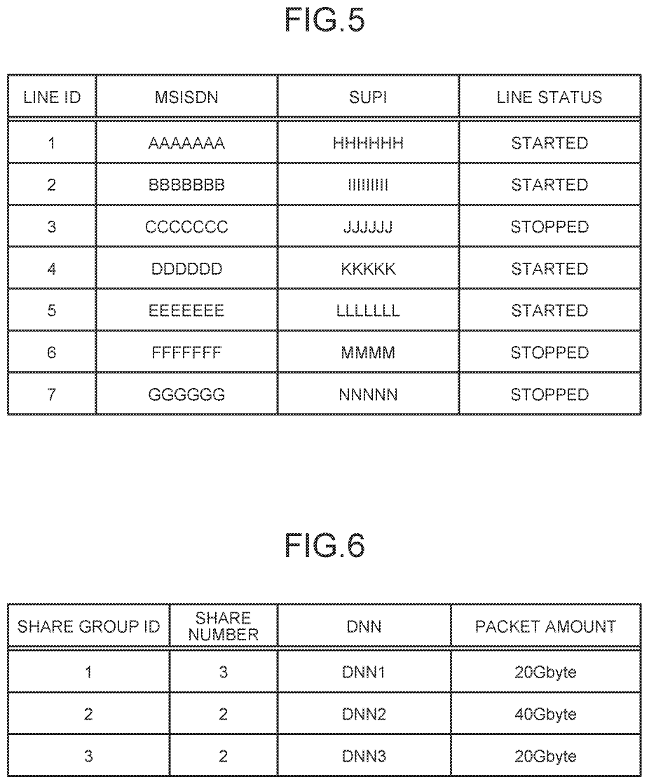

FIG. 5 is a table illustrating an example of the line information table according to the embodiment of the present disclosure. In the line information table illustrated in FIG. 5, information regarding the line ID, MSISDN, SUPI, and the line status is managed.

In the “line ID”, identification information for identifying line information related to a line contract with the cellular communication system 30 is stored. The “line ID” corresponds to the “line ID” in the ticket information table illustrated in FIG. 4.

Information regarding the MSISDN and the SUPI corresponding to the line ID is stored in “MSISDN” and “SUPI”, respectively.

The “line status” indicates whether the line is activated. For example, the user has purchased a ticket whose “ticket ID” is “1” (see FIG. 4). Although details will be described later, when the ticket is purchased, the line is activated. As illustrated in FIG. 5, the line in which the “status” of the ticket is “purchased” (see FIG. 4) is managed as “started” in the “line status”. On the other hand, the line whose “status” of the ticket is “unpurchased” (see FIG. 4) is not activated, and the “line status” is managed as “stopped” as illustrated in FIG. 5.

### (Share Group Information Table)

Description returns to FIG. 3. As illustrated in FIG. 3, the storage unit 120 stores the share group information regarding a share group in a share group information table. The share group information includes, for example, at least one of a share group ID, a share number, a data network name (DNN), and information regarding a packet amount.

FIG. 6 is a table illustrating an example of the share group information table according to the embodiment of the present disclosure. In the share group information table illustrated in FIG. 6, information regarding the share group ID, the share number, the DNN, and the packet amount is managed.

In the “share group ID”, identification information for identifying a share group managed by the platform 10 is stored. This “share group ID” corresponds to the “share group ID” in the ticket information table illustrated in FIG. 4.

In the “share number”, information regarding the number of tickets included in one share group is stored. For example, in FIG. 4, the number of tickets whose “share group ID” is “1” is “3”. Therefore, “3” is stored in the “share number” whose “share group ID” is “1” in FIG. 6.

In the “DNN”, information regarding the DNN of each line is stored. As illustrated in FIG. 6, in the embodiment of the present disclosure, a share group is constructed for each DNN at the time of line contract. In other words, the platform 10 manages lines (tickets) having the same DNN as the same share group at the time of line contract.

In the “packet amount”, information regarding an upper limit of the data communication amount shared by the share group is stored. In the example in FIG. 6, the share group whose “share group ID” is “1” has the “packet amount” of “20 Gbyte”, and the “share number” of “3”. Therefore, up to three terminal devices 40 that have purchased tickets share the packet amount of up to 20 Gbyte to receive the service.

### (Service Information Table)

Description returns to FIG. 3. As illustrated in FIG. 3, the storage unit 120 stores the service information regarding a service in a service information table. The service information includes, for example, at least one of a service ID, a service name, a start date and time, an end date and time, a service status, and information regarding an address.

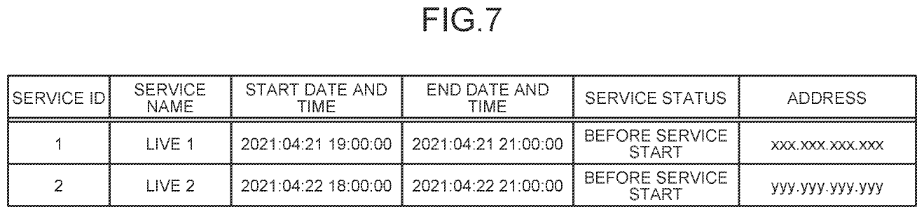

FIG. 7 is a table illustrating an example of the service information table according to the embodiment of the present disclosure. In the service information table illustrated in FIG. 7, information regarding the service ID, the service name, the start date and time, the end date and time, the service status, and the address is managed.

In the “service ID”, identification information for identifying a service managed by the platform 10 is stored. This “service ID” corresponds to the “service ID” in the ticket information table illustrated in FIG. 4.

In the “service name”, a name indicating the service type, such as “Live 1” and “Live 2” are stored in the example in FIG. 7. The “service name” may be the same as or different from the “ticket name” (see FIG. 4).

In the “start date and time” and the “end date and time”, the start date and time and the end date and time of the service are stored, respectively. In the “address”, an address of the service server 20 that provides the service is stored.

### [Control Unit 130]

Description returns to FIG. 2. The control unit 130 is a controller that controls each unit of the information processing apparatus 100. The control unit 130 is realized by, for example, a processor such as a central processing unit (CPU), a micro processing unit (MPU), or a graphics processing unit (GPU). For example, the control unit 130 is implemented by a processor executing various programs stored in the storage device inside the information processing apparatus 100 using a random access memory (RAM) or the like as a work area. Note that the control unit 130 may be realized by an integrated circuit such as an application specific integrated circuit (ASIC) or a field programmable gate array (FPGA). Any of the CPU, the MPU, the GPU, the ASIC, and the FPGA can be regarded as the controller.

The control unit 130 includes a contract acceptance unit 131, a contract control unit 132, a service control unit 133, and a QoS control unit 134. Each block (contract acceptance unit 131 to QoS control unit 134) configuring the control unit 130 is a functional block indicating a function of the control unit 130. These functional blocks may be software blocks or hardware blocks. For example, each of the functional blocks described above may be one software module realized by software (microprogram), or may be one circuit block on a semiconductor chip (die). It is apparent that each functional block may be one processor or one integrated circuit. A configuration method of the functional blocks is arbitrary. Note that the control unit 130 may be configured with a functional unit different from the above-described functional block.

### (Contract Acceptance Unit 131)

The contract acceptance unit 131 accepts a ticket purchase by the user. The contract acceptance unit 131 may accept the ticket purchase directly by the user, or may accept the ticket purchase through the terminal device 40 used by the user.

When the user purchases a ticket, for example, the contract acceptance unit 131 updates the “status” in the ticket information table in the storage unit 120 from “unpurchased” to “purchased”. In addition, when the user purchases the ticket, the contract acceptance unit 131 notifies the contract control unit 132 of the purchase.

### (Contract Control Unit 132)

The contract control unit 132 performs the line contract, on behalf of the user, with the MNO (hereinafter also referred to as a carrier) that operates and/or manages the cellular communication system 30 via the BSS (not illustrated) of the cellular communication system 30. The contract control unit 132 performs a subscription contract of the line according to the service information (e.g., the number of tickets to be sold and service quality required for the service) acquired by the service control unit 133 described later. The contract control unit 132 updates, for example, the line information table and the share group information table according to the concluded contract.

When the contract control unit 132 receives a notification regarding the ticket purchase by the user from the contract acceptance unit 131, the contract control unit 132 activates the line corresponding to the “ticket ID” of the ticket purchased. For example, the contract control unit 132 activates the line via the BSS (not illustrated) of the cellular communication system 30. For example, when the line is activated, the contract control unit 132 updates the “line status” in the line information table in the storage unit 120 from “stopped” to “started”.

In addition, the contract control unit 132 performs a cancellation process of the line whose service has ended. After the cancellation process, the contract control unit 132 can delete the information regarding the line that has been cancelled from the storage unit 120.

### (Service Control Unit 133)

The service control unit 133 acquires the service information regarding the service from the service server 20 via the communication unit 110. The service information may include at least one piece of the following information:
Information regarding the name of the service (service name) provided by the service server 20
Ticket type (ticket name) to be sold
Information regarding the number of tickets sold for each ticket type
Information regarding sales price for each ticket type
Information regarding service start date and time
Information regarding service end date and time
Information regarding service quality required for each service type

The information regarding the service quality required for each service type may be information indicating a specific packet amount and/or throughput, or may be information indicating an index indicating the service quality (e.g., high quality and low quality).

When the service control unit 133 acquires the service information, the service control unit 133 updates the ticket information table, the service information table, and the like in the storage unit 120. In addition, when the service control unit 133 acquires the service information, the service control unit 133 requests the contract control unit 132 to conclude the subscription contract of the line according to the service information acquired.

The service control unit 133 notifies the service server 20 of the service start at the service start time based on the service start date and time (“start date and time” in FIG. 7) stored in the service information table. In addition, the service control unit 133 notifies the QoS control unit 134 of the start of the service.

The service control unit 133 notifies the service server 20 of the service end at the service end time based on the service end date and time (“end date and time” in FIG. 7) stored in the service information table. In addition, the service control unit 133 notifies the QoS control unit 134 of the service end at the service end time.

### (QoS Control Unit 134)

When the QoS control unit 134 receives a notification of service start from the service control unit 133, the QoS control unit 134 determines a resource of the terminal device 40 that receives the service. For example, the QoS control unit 134 determines an average bandwidth for each share group while providing the service to the terminal device 40.

More specifically, the QoS control unit 134 determines the average bandwidth of the terminal device 40 based on at least one of the upper limit of the packet amount allocated to the share group (see “packet amount” in FIG. 6), the number of activated lines included in the share group, and the service providing time. The QoS control unit 134 calculates the average bandwidth of the terminal device 40 receiving the service for each share group based on Formula (1) below.

$$Average bandwidth = Packet amount allocated to share group / \qquad ( 1 )$$

$$( Number of activated lines \times Service providing time )$$

Note that the service providing time can be calculated from the service start time and the service end time.

The QoS control unit 134 requests the determined average bandwidth from the cellular communication system 30. The QoS control unit 134 may make a request for the average bandwidth via a network exposure function (NEF) (not illustrated) of the cellular communication system 30 or may make a request directly to a policy control function (PCF) (not illustrated).

When the QoS control unit 134 receives a notification of service end from the service control unit 133, the QoS control unit 134 determines to release the resource used by the terminal device 40. The QoS control unit 134 requests the cellular communication system 30 to release the resource (e.g., bandwidth) used for providing the service. The QoS control unit 134 may notify the release of the bandwidth via the NEF of the cellular communication system 30 or may directly notify the PCF.

Further, the QoS control unit 134 may update the average bandwidth requested to the cellular communication system 30 while the service server 20 provides the service. For example, the QoS control unit 134 calculates the average bandwidth of the terminal device 40 that receives the service at a predetermined cycle.

The QoS control unit 134 calculates the average bandwidth based on, for example, the packet amount that can be used by the share group at the time of calculating the average bandwidth (hereinafter also referred to as a remaining packet amount) and remaining service providing time (hereinafter also referred to as a remaining providing time). The QoS control unit 134 calculates the average bandwidth by using, for example, Formula (2) below.

$$Average bandwidth = Remaining packet amount of share group / \qquad ( 2 )$$

$$( Number of activated lines \times Remaining service providing time )$$

Note that the QoS control unit 134 may acquire the remaining packet amount of the share group from the cellular communication system 30. Alternatively, the QoS control unit 134 may acquire the packet amount used by the terminal device 40 included in the share group from the cellular communication system 30 and calculate the remaining packet amount based on the packet amount used.

The Qos control unit 134 requests the determined average bandwidth from the cellular communication system 30. The QoS control unit 134 may make a request for the average bandwidth via the NEF of the cellular communication system 30 or may make a request directly to the PCF.

### 2.2. Configuration Example of Cellular Communication System

Next, an example of a network architecture of the cellular communication system 30 according to the embodiment of the present disclosure will be described. Here, an architecture of a fifth generation mobile communication system (5G) will be described as an example of the network architecture of the cellular communication system 30.

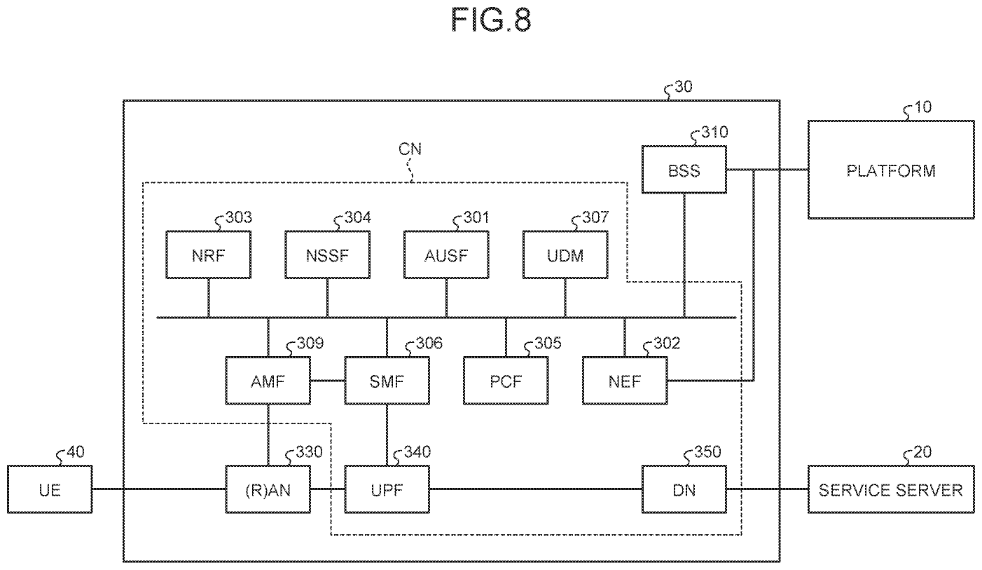

FIG. 8 is a diagram illustrating an example of the architecture of the cellular communication system 30 according to the embodiment of the present disclosure. The cellular communication system 30 includes a core network CN, an (R) AN 330, and a BSS 310.

The core network CN of 5G is also referred to as a 5G core/next generation core (5GC/NGC). Hereinafter, the core network CN of 5G is also referred to as the 5GC/NGC. The core network CN is connected to user equipment (UE) 40 via the (R) AN 330. The UE 40 is the terminal device 40.

The (R) AN 330 has a function of enabling connection to a radio access network (RAN) and connection to an access network (AN) other than the RAN. The (R) AN 330 includes a base station called a gNB or a ng-eNB.

The core network CN mainly performs connection permission and session management when the UE 40 is connected to the network. The core network CN may include one or a plurality of information processing apparatuses. The core network CN includes a user plane function group and a control plane function group.

The user plane function group includes a user plane function (UPF) 340 and a data network (DN) 350. The UPF 340 has a function of user plane processing. The UPF 340 includes a routing/forwarding function of data handled in a user plane. The DN 350 has a function of providing an entity, such as a mobile network operator (MNO), that provides a connection to an operator's own service, providing an Internet connection, or providing a connection to a third party service, such as the service server 20. As described above, the user plane function group plays a role of a gateway serving as a boundary between the core network CN and the Internet.

The control plane function group includes an authentication server function (AUSF) 301, an NEF 302, a network repository function (NRF) 303, a network slice selection function (NSSF) 304, a PCF 305, a session management function (SMF) 306, a unified data management (UDM) 307, and an access and mobility management function (AMF) 309.

The AUSF 301 has an authentication function. The NEF 302 has a function of providing a capability and an event of a network function to a third party, an application function (AF), or an edge computing function. In the present embodiment, for example, the NEF 302 presents the function of the core network CN as the API to the platform 10 or the service provider.

The NRF 303 has a function of finding a network function and holding a profile of the network function. The NSSF 304 has a function related to selection of a network slice.

The PCF 305 has a function related to control of a line charging rule and a network policy. Although FIG. 8 illustrates a case where the platform 10 is connected to the core network CN via the NEF 302, the platform 10 may be directly connected to the PCF 305.

The SMF 306 has functions such as session management and IP assignment and management of the UE 40. The UDM 307 has functions of generating 3GPP AKA authentication information and processing the user ID. The AMF 309 has functions such as registration processing, connection management, and mobility management of the UE 40.

Note that communication between the platform 10 and the PCF 305 and communication between the platform 10 and the NEF 302 are performed using, for example, an N5 interface and an N33-N30 interface in 3GPP TS 23.501.

For example, as described above, when making a request for the average bandwidth to the PCF 305, the platform 10 makes the request by using Npcf PolicyAuthorization, regardless of whether the request is made directly to the PCF 305 or through the NEF 302. Note that Npcf PolicyAuthorization is described in Table 5.2.5.1-1 NF Services Provided by PCF in 3GPP TS 23.502.

A type of data used when the platform 10 directly or indirectly interacts with the PCF 305 is described in 6.2.1 (e.g., 6.2.1.2 Input for policy and charging control (PCC) decisions) in 3GPP TS 23.503. More specifically, the platform 10 sets the average bandwidth to bandwidth described in 3GPP TS 23.503, and specifies SUPI in a subscriber identifier. This enables the platform 10 to request, from the PCF 305, the determined average bandwidth as the bandwidth of the line (or the terminal device 40) corresponding to the SUPI.

In addition, the above-described band control device can be realized as, for example, at least one function of the UPF 340, the SMF 306, and the PCF 305.

The BSS 310 is connected to the core network CN and has a function of updating line contract information, a function of issuing a subscriber identity module (SIM), and the like. For example, the BSS 310 can be disclosed, to a carrier or a mobile virtual network operator (MVNO), as an operation terminal (information processing apparatus) or an API installed in a store.

Here, a case where the cellular communication system 30 is the fifth generation mobile communication system (5G) has been described, but the present disclosure is not limited thereto. For example, the cellular communication system 30 may be another wireless communication system.

For example, the cellular communication system 30 may be LTE. In other words, the core network CN of the cellular communication system 30 may be an LTE core network, i.e., evolved packet core (EPC). In this case, the core network CN may include a mobility management entity (MME), a serving gateway (S-GW), a PDN gateway (P-GW), a policy and charging rule function (PCRF), and a home subscriber server (HSS).

The MME is a control node that handles control plane signals, and manages mobility of the terminal device 40. The S-GW/P-GW is a node that handles user plane signals. The PCRF is a control node that performs control related to a policy, such as quality of service (QoS) for a PDU session or a bearer, and charging. The HSS is a control node that handles subscriber data and performs service control.

The platform 10 may, for example, request the average bandwidth to the PCRF. Furthermore, the above-described band control device can be implemented as, for example, at least one of functions of a policy and charging enforcement function (PCEF) and the PCRF. Note that the PCEF may be included in the function of the P-GW.

### 2.3. Server Device

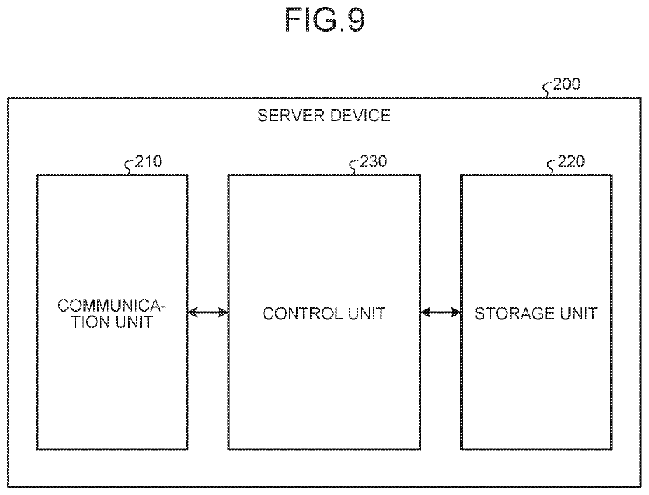

Next, a server device 200 will be described with reference to FIG. 9. FIG. 9 is a block diagram illustrating a configuration example of the server device 200 according to the embodiment of the present disclosure. The server device 200 is, for example, a device that functions as the service server 20.

The server device 200 illustrated in FIG. 9 includes a communication unit 210, a storage unit 220, and a control unit 230. Note that the configuration illustrated in FIG. 9 is a functional configuration, and a hardware configuration may be different from the functional configuration. Furthermore, functions of the server device 200 may be implemented in a distributed manner in a plurality of physically separated configurations. For example, the server device 200 may include a plurality of server devices.

### [Communication Unit 210]

The communication unit 210 is a communication interface for communicating with other devices. The communication unit 210 may be a network interface or a device connection interface. For example, the communication unit 210 may be a local area network (LAN) interface such as a network interface card (NIC), or may be a universal serial bus (USB) interface including a USB host controller and a USB port. Furthermore, the communication unit 210 may be a wired interface or a wireless interface. The communication unit 210 functions as a communication means of the server device 200. The communication unit 210 communicates with the platform 10 and the cellular communication system 30 under the control of the control unit 230.

### [Storage Unit 220]

The storage unit 220 is a data readable/writable storage device such as a dynamic random access memory (DRAM), a static random access memory (SRAM), a flash memory, or a hard disk. The storage unit 220 functions as a storage means of the server device 200.

### [Control Unit 230]

The control unit 230 is a controller that controls each part of the server device 200. The control unit 230 is realized by, for example, a processor such as a central processing unit (CPU), a micro processing unit (MPU), or a graphics processing unit (GPU). For example, the control unit 230 is implemented by a processor executing various programs stored in a storage device inside the server device 200 using a random access memory (RAM) or the like as a work area. Note that the control unit 230 may be realized by an integrated circuit such as an application specific integrated circuit (ASIC) or a field programmable gate array (FPGA). Any of the CPU, the MPU, the GPU, the ASIC, and the FPGA can be regarded as the controller.

The control unit 230 can function as a control unit (application control unit) of an application (not illustrated) that provides a service to the terminal device 40. For example, when the service server 20 is a device that provides a live distribution service for distributing an image captured by a camera (not illustrated) in real time, the control unit 230 controls an application that acquires and distributes the captured image.

### 2.4. Terminal Device

Next, the terminal device 40 according to the embodiment of the present disclosure will be described. The terminal device 40 is a wireless communication device that wirelessly communicates with other communication devices such as the cellular communication system 30 and the platform 10. For example, the terminal device 40 may be a mobile phone, a smart device (smartphone or tablet), a personal digital assistant (PDA), or a personal computer.

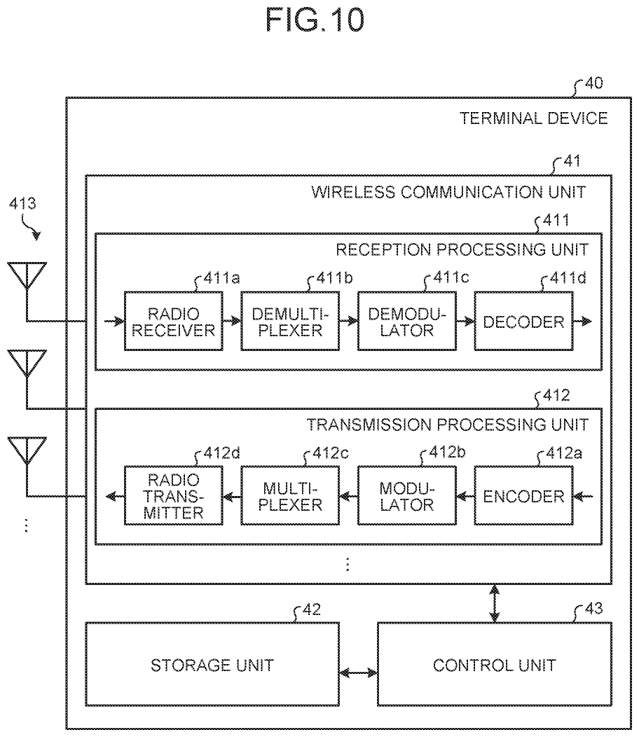

FIG. 10 is a block diagram illustrating a configuration example of the terminal device 40 according to the embodiment of the present disclosure. The terminal device 40 illustrated in FIG. 10 includes a wireless communication unit 41, a storage unit 42, and a control unit 43. Note that the configuration illustrated in FIG. 10 is a functional configuration, and a hardware configuration may be different from the functional configuration. Furthermore, functions of the terminal device 40 may be implemented in a distributed manner in a plurality of physically separated configurations.

### [Wireless Communication Unit 41]

The wireless communication unit 41 is a signal processing unit for wirelessly communicating with other wireless communication devices. The wireless communication unit 41 operates under the control of the control unit 43. The wireless communication unit 41 operates under the control of the control unit 43. The wireless communication unit 41 corresponds to one or a plurality of radio access systems. For example, the wireless communication unit 41 may support both NR and LTE. The wireless communication unit 41 may support other radio access methods such as W-CDMA and cdma2000.

The wireless communication unit 41 includes a reception processing unit 411, a transmission processing unit 412, and an antenna 413. The wireless communication unit 41 may include a plurality of reception processing units 411, a plurality of transmission processing units 412, and a plurality of antennas 413. When the wireless communication unit 41 supports the plurality of radio access methods, each part of the wireless communication unit 41 can be configured individually for each radio access method. For example, the reception processing unit 411 and the transmission processing unit 412 may be individually configured for the LTE and the NR.

The reception processing unit 411 processes a downlink signal received via the antenna 413. The reception processing unit 411 includes a radio receiver 411a, a demultiplexer 411b, a demodulator 411c, and a decoder 411d.

The radio receiver 411a performs, with respect to the downlink signal, down-conversion, removal of an unnecessary frequency component, control of an amplification level, quadrature demodulation, conversion to a digital signal, removal of a guard interval, extraction of a frequency domain signal by fast Fourier transform, and the like. The demultiplexer 411b separates a downlink channel, a downlink synchronization signal, and a downlink reference signal from a signal output from the radio receiver 411a. The downlink channel is, for example, a channel such as a physical broadcast channel (PBCH), a physical downlink shared channel (PDSCH), or a physical downlink control channel (PDCCH). The demodulator 411c demodulates the received signal using a modulation scheme such as BPSK, QPSK, 16 QAM, 64 QAM, or 256 QAM for a modulation symbol of the downlink channel. The decoder 411d performs a decoding process on the demodulated encoded bits of the downlink channel. Decoded downlink data and downlink control information are output to the control unit 43.

The transmission processing unit 412 performs a transmission process of uplink control information and uplink data. The transmission processing unit 412 includes an encoder 412a, a modulator 412b, a multiplexer 412c, and a radio transmitter 412d.

The encoder 412a encodes the downlink control information and the downlink data input from the control unit 43 using an encoding system such as block encoding, convolutional encoding, or turbo encoding. The modulator 412b modulates the coded bits output from the encoder 412a by a predetermined modulation system such as the BPSK, QPSK, 16 QAM, 64 QAM, or 256 QAM. The multiplexer 412c multiplexes the modulation symbol of each channel and an uplink reference signal, and arranges the multiplexed result in a predetermined resource element. The radio transmitter 412d performs various types of signal processing on a signal from the multiplexer 412c. For example, the radio transmitter 412d performs processing such as conversion into a time domain by fast Fourier transform, addition of a guard interval, generation of a baseband digital signal, conversion into an analog signal, quadrature modulation, up-conversion, removal of an extra frequency component, and power amplification. A signal generated by the transmission processing unit 412 is transmitted from the antenna 413.

The antenna 413 is an antenna device (antenna unit) that mutually converts a current and a radio wave. The antenna 413 may include one antenna element (e.g., one patch antenna) or may include a plurality of antenna elements (e.g., a plurality of patch antennas). When the antenna 413 includes a plurality of antenna elements, the wireless communication unit 41 may be configured to be beamformable. For example, the wireless communication unit 41 may be configured to generate a directional beam by controlling the directivity of a radio signal using the plurality of antenna elements.

### [Storage Unit 42]

The storage unit 42 is a storage device capable of reading and writing data, such as a DRAM, an SRAM, a flash memory, or a hard disk. The storage unit 42 functions as a storage means of the terminal device 40.

### [Control Unit 43]

The control unit 43 is a controller that controls each part of the terminal device 40. The control unit 43 is realized by, for example, a processor such as the CPU or the MPU. For example, the control unit 43 is realized by a processor executing various programs stored in a storage device inside the terminal device 40 using the RAM or the like as a work area. Note that the control unit 43 may be realized by an integrated circuit such as the ASIC or the FPGA. Any of the CPU, the MPU, the ASIC, and the FPGA can be regarded as the controller. Furthermore, the control unit 43 may be realized by the GPU in addition to or instead of the CPU.

### 3. Information Processing

An example of information processing executed by the information processing system 1 according to the embodiment of the present disclosure will be described. In the information processing system 1 according to the embodiment of the present disclosure, a line activating process and a service providing process are executed as information processing.

### 3.1. Line Activating Process

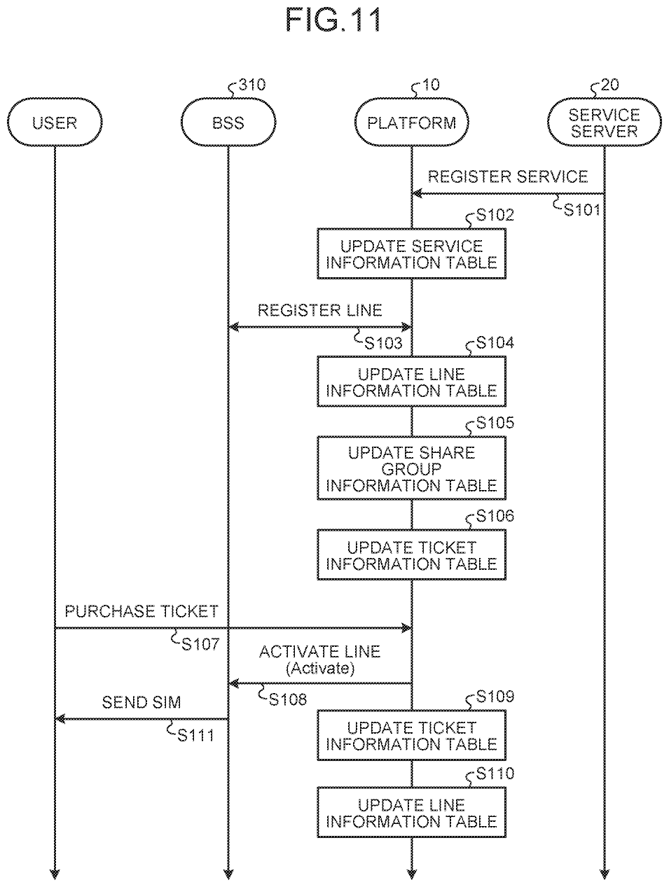

First, the line activating process executed by the information processing system 1 will be described with reference to FIG. 11. FIG. 11 is a sequence diagram illustrating an example of a flow of the line activating process according to the embodiment of the present disclosure.

As illustrated in FIG. 11, the platform 10 receives service registration from the service server 20 (Step S101). Here, for example, it is assumed that registration of a service whose “service name” is “Live 1” is received from the platform 10. Furthermore, the platform 10 acquires the service information (number, type, service start time, end time, etc., of a ticket sold) regarding the service at the time of service registration.

The platform 10 updates the service information table based on the service information acquired (Step S102). For example, the platform 10 assigns service ID “1” to a service whose registration has been accepted, and stores the service start time, the end time, and the like in the service information table.

Next, the platform 10 performs line registration with respect to the BSS 310 (Step S103). More specifically, the platform 10 performs the line registration with respect to the cellular communication system 30 via the BSS 310. At this time, the platform 10 performs the line registration according to the ticket type and the number of tickets sold.

For example, as lines for the service having the service name “Live 1”, the platform 10 registers lines with line IDs “1” to “3” as lines for tickets having the ticket name “Live 1”. As lines for the service having the service name “Live 1”, the platform 10 also registers lines with line IDs “4” and “5” as lines for tickets having the ticket name “Live 1 Premium”.

The platform 10 updates the line information table based on the information regarding the registered line (Step S104). For example, the platform 10 updates the line information corresponding to the line IDs “1” to “5” illustrated in FIG. 5. Note that, in FIG. 5, the line status of the line IDs “1”, “2”, “4”, and “5” are “started”, but it is assumed that the line status is “stopped” in the step that the platform 10 registers the lines.

The description returns to FIG. 11. The platform 10 updates the share group information table based on the information regarding the registered lines (Step S105). For example, the platform 10 classifies the plurality of registered lines into different share groups for each DNN, and updates the share group information table. In the example in FIG. 5, the platform 10 classifies the lines such that the line IDs “1” to “3” are included in one share group and the line IDs “4” and “5” are included in one share group.

The description returns to FIG. 11. The platform 10 updates the ticket information table based on the information regarding the registered lines (Step S106). For example, the platform 10 updates the ticket information corresponding to “Live 1” and “Live 1 Premium” illustrated in FIG. 4. Note that, in FIG. 4, the status of the tickets with ticket IDs “1”, “2”, “4”, and “5” is “purchased”, but it is assumed that the status is “unpurchased” in the step that the platform 10 registers the lines.

The description returns to FIG. 11. Next, it is assumed that the user purchases the ticket sold by the platform 10 (Step S107). The platform 10 requests the BSS 310 to activate the line (Step S108). For example, when the user purchases a ticket with the ticket ID “1”, the platform 10 requests the BSS 310 to activate a SIM corresponding to a line with the line ID “1” and to transmit the SIM.

When the line is activated, the platform 10 updates the ticket information table (Step S109). The platform 10 updates the status of the line ID “1” in FIG. 4 to “purchased”.

The description returns to FIG. 11. The platform 10 updates the ticket information table (Step S110). The platform 10 updates the line status of the line ID “1” in FIG. 5 to “start”.

The description returns to FIG. 11. When the BSS 310 receives a SIM transmission request, the BSS 310 transmits the SIM to the user who has purchased the ticket (Step S111). For example, the SIM is delivered to the user by mail. When the user installs the SIM in the terminal device 40, the user can receive the service from the service server 20 via the cellular communication system 30.

In the following description, it is assumed that tickets with ticket IDs “1”, “2”, “4”, and “5” illustrated in FIG. 4 have been purchased.

### 3.2. Service Providing Process

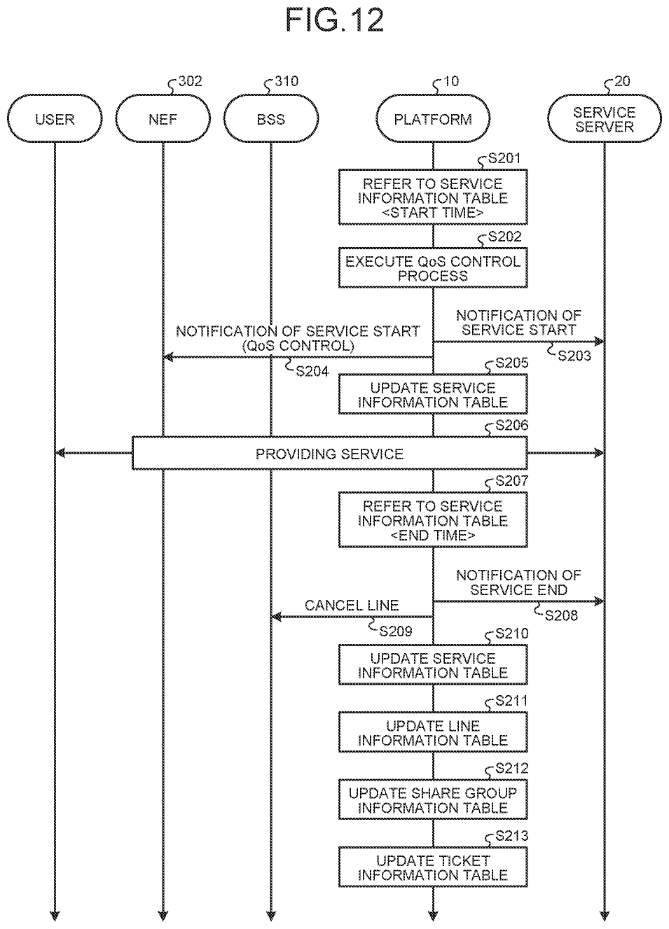

FIG. 12 is a sequence diagram illustrating an example of a flow of the service providing process according to the embodiment of the present disclosure. Here, the example of the flow of the service providing process for providing the service whose service name is “Live 1” will be described.

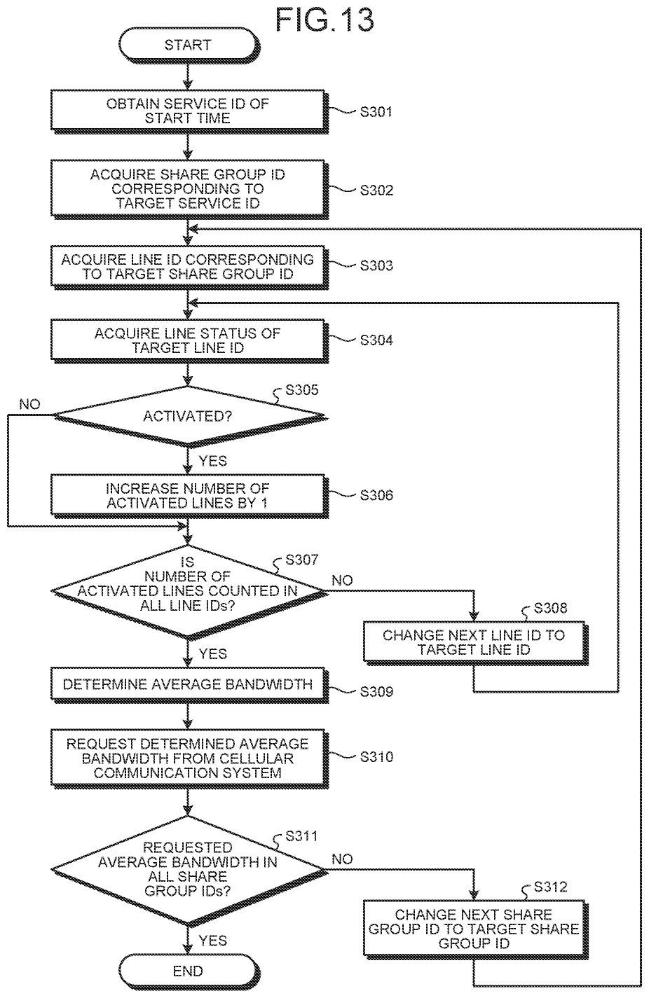

As illustrated in FIG. 12, the platform 10 refers to the start time in the service information table (Step S201) and monitors the start time of the service. At the start time of the service, the platform 10 performs a QoS control process (Step S202). The platform 10 executes the QoS control process to determine an average bandwidth to be allocated to the terminal device 40 that receives the service. Note that details of the QoS control process will be described later with reference to FIG. 13.

The platform 10 transmits the service start notification to the service server 20 (Step S203). In addition, the platform 10 sends the service start notification including a QoS control request to the NEF 302 (Step S204). Note that, in FIG. 12, the platform 10 requests the QoS control (e.g., average bandwidth) to the PCF 305 by transmitting the service start notification to the NEF 302, but the present disclosure is not limited thereto. For example, the platform 10 may request the Qos control by directly transmitting the service start notification to the PCF 305.

The platform 10 updates the service information table (Step S205). For example, the platform 10 updates the service status of “Live 1” in FIG. 7 to “Serving”.

The description returns to FIG. 12. When the service server 20 receives the service start notification from the platform 10, the service server 20 provides the service to the user using the line of the cellular communication system 30 (Step S206). For example, the service server 20 provides the service (e.g., distribution of captured images) to the terminal device 40 used by the user. In other words, the service is provided to the terminal device 40 on which the SIM sent from the BBS 310 is installed.

While the service server 20 is providing the service, the platform 10 refers to the end time in the service information table (Step S207) and monitors the end time of the service.

When the service end time comes, the platform 10 transmits a service end notification to the service server 20 (Step S208). As a result, the service server 20 ends the service to the user.

After the service has ended, the platform 10 updates the service information table (Step S210). The platform 10 updates the line information table (Step S211). The platform 10 updates the share group information table (Step S212). The platform 10 updates the ticket information table (Step S213). For example, the platform 10 deletes the information corresponding to “Live 1” from the service information table, the line information table, the share group information table, and the ticket information table.

Note that, in FIG. 12, when the service start time comes, the platform 10 executes the QoS control process and notifies the service server 20 of the service start, but the present disclosure is not limited thereto. For example, the platform 10 may perform the QoS control process before the service start time so that the service server 20 can start the service at the exact service start time. For example, the platform 10 may execute the QoS control process after ticket sales ends or a predetermined time before the service start time, and transmits the service start notification to the service server 20 at the service start time.

### 3.3. QoS Control Process

FIG. 13 is a flowchart illustrating an example of a flow of the QoS control process according to the embodiment of the present disclosure. The QoS control process illustrated in FIG. 13 is executed by the platform 10, for example, in Step S202 of the service providing process in FIG. 12.

As illustrated in FIG. 13, the platform 10 refers to the service information table and obtains the service ID of the start time (Step S301). Here, the platform 10 obtains, for example, the service ID “1” (see FIG. 7). Hereinafter, the service ID acquired by the platform 10 in Step S301 is also referred to as a target service ID.

As illustrated in FIG. 13, the platform 10 refers to the ticket information table to acquire the share group ID corresponding to the target service ID (Step S302). Here, the platform 10 obtains, for example, the share group ID “1” (see FIG. 4). Hereinafter, the share group ID acquired by the platform 10 in Step S302 is also referred to as a target share group ID.

The description returns to FIG. 13. The platform 10 refers to the ticket information table and acquires a line ID corresponding to the target share group ID (Step S303). Here, the platform 10 obtains, for example, the line ID “1” (see FIG. 4). Hereinafter, the line ID acquired by the platform 10 in Step S303 is also referred to as a target line ID.

The description returns to FIG. 13. The platform 10 refers to the line information table and acquires the line status of the target line ID (Step S304). Here, since the line ID “1” is the target line ID, the platform 10 acquires, for example, “started” as the line status of the target line ID (see FIG. 4).

The description returns to FIG. 13. Based on the acquired line status, the platform 10 determines whether the target line ID is already activates (Step S305). For example, when the acquired line status is “started”, the platform determines that the line is already activated, and when the acquired line status is “stopped”, the platform 10 determines that the line is not activated.

When the line has not been activated (Step S305; No), the platform 10 proceeds to Step S307.

When the line is already activated (Step S305; Yes), the platform 10 increases the number of activated lines by 1 (Step S306).

Next, the platform 10 determines whether the number of activated lines has been counted for all the line IDs included in the target share group ID (Step S307).

For example, when the target line ID is “1”, the platform 10 has not counted the number of activated lines for the line IDs “2” and “3” included in the target share group ID. As described above, when there is a line ID whose number of activated lines has not been counted (Step S307; No), the platform 10 changes the next line ID to the target line ID (Step S308), and returns to Step S304. For example, the platform 10 changes the line ID “2” to the target line ID, and returns to Step S304.

On the other hand, when the number of activated lines has been counted for all the line IDs (e.g., line IDs “1” to “3”) included in the target share group ID (Step S307; Yes), the platform 10 determines an average bandwidth to allocate to the activated lines (Step S309). The platform 10 determines the average bandwidth of the activated lines corresponding to the target share group ID by using Formula (1) described above.

Here, as illustrated in FIG. 5, in the line IDs “1” to “3”, the number of activated lines (“started” in line status) is two (line IDs “1” and “2”). As illustrated in FIG. 6, the packet amount of the share group ID “1” is “20 Gbyte”. As illustrated in FIG. 7, the service with the service ID “1” is provided for two hours from 19:00 to 21:00 on Apr. 21, 2021. In other words, the two lines with line IDs “1” and “2” share 20 Gbyte and perform communication for two hours during which the service is provided.

Therefore, the average bandwidth W that can be used by the line IDs “1” and “2” without coupon shortage while the service is provided is W=20 Gbyte/(2×2 hours)=11.11 mbps. The platform 10 determines 11.11 mbps as the average bandwidth to be requested from the cellular communication system 30.

The description returns to FIG. 13. The platform 10 requests the average bandwidth determined in Step S309 from the cellular communication system 30 (Step S310). Note that the process in Step S310 can be executed as the process in Step S304 in FIG. 12.

The description returns to FIG. 13. The platform 10 determines whether the average bandwidth has been requested for all the share group IDs included in the target service ID (Step S311).

For example, when the target service ID is “1”, the platform 10 has made a request for the average bandwidth using the share group ID “1” corresponding to the target service ID as the target share group ID. On the other hand, the platform 10 does not request the average bandwidth for the share group ID “2” corresponding to the target service ID “1”. As described above, when there is a share group ID that has not made a request for the average bandwidth (Step S311; No), the platform 10 changes the next share group ID to the target share group ID (Step S312), and returns to Step S303. For example, the platform 10 changes the share group ID “2” to the target share group ID, and returns to Step S303.

On the other hand, when the request for the average bandwidth is made for all the share group IDs (e.g., share group IDs “1” and “2”) included in the target service ID (Step S311; Yes), the platform 10 ends the process.

### 4. Modifications

The above-described embodiments are examples, and various modifications and applications are possible.

For example, in the above-described embodiment, the BSS 310 sends the SIM to the user, but the present disclosure is not limited thereto. For example, instead of a physical SIM (e.g., SIM card), an electronic SIM called an eSIM (embedded SIM) or a software SIM may be used.

In this case, for example, the BSS 310 provides the eSIM to the terminal device 40 used by the user via the SM-DP+ 311.

Here, the SM-DP+311 is a node configuring an eSIM system for consumers. The SM-DP+ 311 is defined by, for example, GSM Association (GSMA). The SM-DP+ 311 manages a profile of the eSIM.

The user accesses the SM-DP+ 311 using an activation code acquired from the BSS 310. By downloading the profile from the SM-DP+ 311 to the terminal device 40, the user can install the eSIM in the terminal device 40, and can use the line of the cellular communication system 30.

Note that the BSS 310 can distribute the activation code to the user using, for example, a QR code (registered trademark), a character string, or the like.

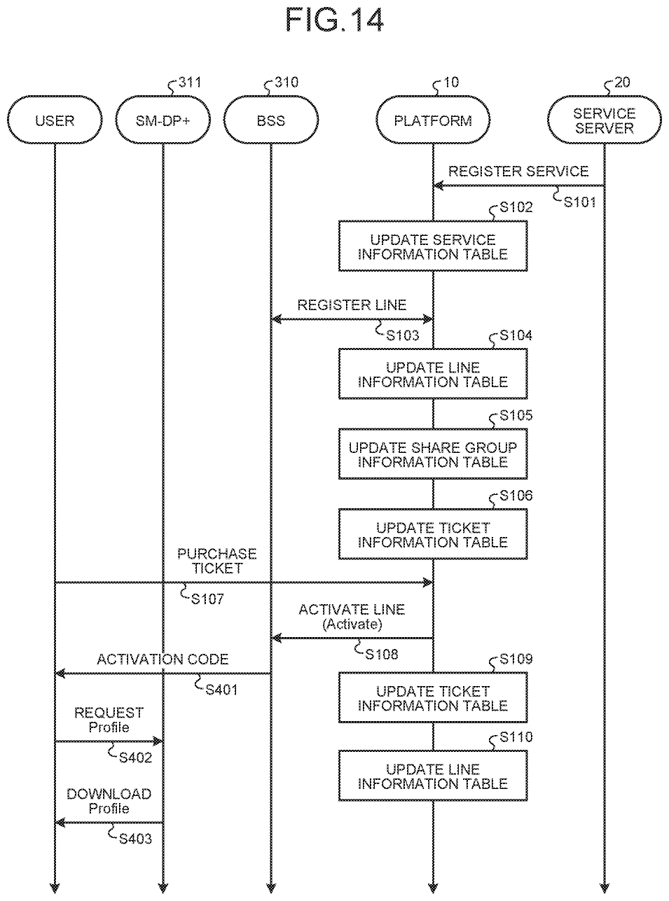

FIG. 14 is a sequence diagram illustrating an example of a flow of a line activating process according to a modification of the embodiment of the present disclosure. Note that, since the flow of process up to Step S110 is the same as that in FIG. 11, the same reference numerals are given to omit description thereof.

When the BSS 310 accepts a request for activating the line, the BSS 310 causes the cellular communication system 30 to activate the line and provides the user with the activation code (Step S401). For example, the BSS 310 provides the user with the activation code by transmitting the activation code to the terminal device 40 used by the user.

The user receiving the activation code accesses the SM-DP+ 311, using the activation code, and requests the profile (Step S402). The user acquires the eSIM by downloading the profile from SM-DP+ 311 (Step S403).

In this way, by using the eSIM, the information processing system 1 does not need to send the SIM card. In addition, the user can obtain the eSIM at an arbitrary timing after purchasing the ticket. As a result the user convenience can be further improved.

The control device that controls the information processing apparatus 100, the server device 200, and the terminal device 40 of the present embodiment may be realized by a dedicated computer system or a general-purpose computer system.

For example, a communication program for executing the above-described operation is stored and distributed in a computer-readable recording medium such as an optical disk, a semiconductor memory, a magnetic tape, or a flexible disk. Then, for example, the program is installed on a computer, and the above-described processes are executed to configure the control device. At this time, the control device may be the information processing apparatus 100, the server device 200, and a device outside the terminal device 40 (e.g., personal computer). Furthermore, the control device may be the information processing apparatus 100, the server device 200, and a device inside the terminal device 40 (e.g., control unit 130, control unit 230, and control unit 43).

In addition, the above communication program may be stored in a disk device provided in a server device on a network such as the Internet so that the communication program can be downloaded to the computer. In addition, the above-described functions may be realized by cooperation of an operating system (OS) and application software. In this case, a portion other than the OS may be stored in a medium and distributed, or a portion other than the OS may be stored in the server device and downloaded to the computer.

Among the processes described in the above embodiments, all or part of the processes described as being performed automatically can be performed manually, or all or part of the processes described as being performed manually can be performed automatically by a known method. In addition, the processing procedure, specific name, and information including various data and parameters illustrated in the above document and the drawings can be arbitrarily changed unless otherwise specified. For example, various types of information illustrated in each drawing are not limited to the illustrated information.

In addition, each component of each device illustrated in the drawings is functionally conceptual, and is not necessarily physically configured as illustrated in the drawings. In other words, a specific form of distribution and integration of each device is not limited to the illustrated form, and all or a part thereof can be functionally or physically distributed and integrated in an arbitrary unit according to various loads, usage conditions, and the like. Note that this configuration by distribution and integration may be performed dynamically.

In addition, the above-described embodiments can be appropriately combined in a region in which the processing content do not contradict each other. Furthermore, the order of each step illustrated in the flowcharts and the sequence diagrams of the above-described embodiments may be changed as appropriate.

Furthermore, for example, the present embodiment can be implemented as any configuration constituting an apparatus or a system, for example, a processor as a system large scale integration (LSI) or the like, a module using a plurality of processors or the like, a unit using a plurality of modules or the like, a set obtained by further adding other functions to the unit, or the like (i.e., configuration of a part of device).

Note that, in the present embodiment, the system means a set of a plurality of components (devices, modules (parts), etc.), and it does not matter whether or not all the components are in the same housing. Therefore, a plurality of devices housed in separate housings and connected via a network and one device in which a plurality of modules is housed in one housing are both systems. For example, the information processing apparatus 100 of the present embodiment can be realized as one system.

Furthermore, for example, the present embodiment can adopt a configuration of cloud computing in which one function is shared and processed by a plurality of devices in cooperation via a network.

### 5. Conclusion

Although the embodiments of the present disclosure have been described above, the technical scope of the present disclosure is not limited to the above-described embodiments as it is, and various modifications can be made without departing from the gist of the present disclosure. In addition, the components of different embodiments and modifications may be appropriately combined.

Note that the effects of each embodiment described in the present specification are merely examples and not limited thereto, and other effects may be provided.

The present technology can also have the following configurations.
(1)

An information processing apparatus comprising a control unit configured to:
request a cellular communication system to perform activation of a communication line to be used by a plurality of terminal devices that are service providing targets;
assign the plurality of terminal devices to at least a group according to a service to be provided;
determine a resource to be allocated to the plurality of terminal devices corresponding to the group when the service is started to be provided to the plurality of terminal devices corresponding to the group; and
request the cellular communication system to secure the resource.
(2)

The information processing apparatus according to (1), wherein the control unit determines, as the resource, an average bandwidth while the service is provided, the average bandwidth being determined based on at least one of a packet amount available to the group, a number of the plurality of terminal devices corresponding to the group, and a providing time of the service.
(3)

The information processing apparatus according to (1) or (2), wherein each of the plurality of terminal devices receives the service by using a subscriber identity module (SIM) card or an embedded SIM (eSIM).
(4)

The information processing apparatus according to any one of (1) to (4), wherein
the control unit:
accepts an application for use of the service from a user, and
requests the cellular communication system to perform the activation of the communication line for each of the plurality of terminal devices used by the user.
(5)

The information processing apparatus according to claim 1, wherein the control unit registers the communication line with the cellular communication system.
(6)

The information processing apparatus according to any one of (1) to (5), wherein the control unit cancels the communication line when the service ends.
(7)

The information processing apparatus according to any one of (1) to (6), wherein the control unit acquires service information regarding the service from a service server that provides the service to the plurality of terminal devices.
(8)

The information processing apparatus according to any one of (1) to (7), wherein the control unit notifies a service server of at least one of start and end of the service, the service server providing the service to the plurality of terminal devices.
(9)

The information processing apparatus according to any one of (1) to (8), wherein the control unit requests the resource from a policy control function (PCF) of the cellular communication system.
(10)

The information processing apparatus according to any one of (1) to (9), wherein the control unit requests the resource via a network exposure function (NEF) of the cellular communication system.
(11)

The information processing apparatus according to any one of (1) to (10), wherein, among a plurality of the communication lines registered in the cellular communication system, the control unit groups the communication lines with same data network name (DNN) into the group.
(12)

An information processing method comprising;
requesting a cellular communication system to activate a communication line used by a plurality of terminal devices that are service providing targets;
assigning the plurality of terminal devices to at least a group according to a service to be provided;
determining a resource to be allocated to the plurality of terminal devices corresponding to the group when the service is started to be provided to the plurality of terminal devices corresponding to the group; and
requesting the cellular communication system to secure the resource.
(13)

An information processing system comprising a control unit configured to:
request a cellular communication system to activate a communication line to be used by a plurality of terminal devices that are service providing targets;
assign the plurality of terminal devices to at least a group according to a service to be provided;
determine a resource to be allocated to the plurality of terminal devices corresponding to the group when the service is started to be provided to the plurality of terminal devices corresponding to the group; and
request the cellular communication system to secure the resource.

### REFERENCE SIGNS LIST

1 INFORMATION PROCESSING SYSTEM
10 PLATFORM
20 SERVICE SERVER
30 CELLULAR COMMUNICATION SYSTEM
40 TERMINAL DEVICE
41 WIRELESS COMMUNICATION UNIT
42 STORAGE UNIT
43 CONTROL UNIT
100 INFORMATION PROCESSING APPARATUS
110 COMMUNICATION UNIT
120 STORAGE UNIT
130 CONTROL UNIT
131 CONTRACT ACCEPTANCE UNIT
132 CONTRACT CONTROL UNIT
133 SERVICE CONTROL UNIT
134 QoS CONTROL UNIT
200 SERVER DEVICE
210 COMMUNICATION UNIT
220 STORAGE UNIT
230 CONTROL UNIT

1. An information processing apparatus comprising a control unit configured to:
request a cellular communication system to perform activation of a communication line to be used by a plurality of terminal devices that are service providing targets;
assign the plurality of terminal devices to at least a group according to a service to be provided;
determine a resource to be allocated to the plurality of terminal devices corresponding to the group when the service is started to be provided to the plurality of terminal devices corresponding to the group; and
request the cellular communication system to secure the resource.

2. The information processing apparatus according to claim 1, wherein the control unit determines, as the resource, an average bandwidth while the service is provided, the average bandwidth being determined based on at least one of a packet amount available to the group, a number of the plurality of terminal devices corresponding to the group, and a providing time of the service.

3. The information processing apparatus according to claim 1, wherein each of the plurality of terminal devices receives the service by using a subscriber identity module (SIM) card or an embedded SIM (eSIM).

4. The information processing apparatus according to claim 1, wherein
the control unit:
accepts an application for use of the service from a user, and
requests the cellular communication system to perform the activation of the communication line for each of the plurality of terminal devices used by the user.

5. The information processing apparatus according to claim 1, wherein the control unit registers the communication line with the cellular communication system.

6. The information processing apparatus according to claim 1, wherein the control unit cancels the communication line when the service ends.

7. The information processing apparatus according to claim 1, wherein the control unit acquires service information regarding the service from a service server that provides the service to the plurality of terminal devices.

8. The information processing apparatus according to claim 1, wherein the control unit notifies a service server of at least one of start and end of the service, the service server providing the service to the plurality of terminal devices.

9. The information processing apparatus according to claim 1, wherein the control unit requests the resource from a policy control function (PCF) of the cellular communication system.

10. The information processing apparatus according to claim 1, wherein the control unit requests the resource via a network exposure function (NEF) of the cellular communication system.

11. The information processing apparatus according to claim 1, wherein, among a plurality of the communication lines registered in the cellular communication system, the control unit groups the communication lines with same data network name (DNN) into the group.

12. An information processing method comprising;
requesting a cellular communication system to activate a communication line used by a plurality of terminal devices that are service providing targets;
assigning the plurality of terminal devices to at least a group according to a service to be provided;
determining a resource to be allocated to the plurality of terminal devices corresponding to the group when the service is started to be provided to the plurality of terminal devices corresponding to the group; and
requesting the cellular communication system to secure the resource.

13. An information processing system comprising a control unit configured to:
request a cellular communication system to activate a communication line to be used by a plurality of terminal devices that are service providing targets;
assign the plurality of terminal devices to at least a group according to a service to be provided;
determine a resource to be allocated to the plurality of terminal devices corresponding to the group when the service is started to be provided to the plurality of terminal devices corresponding to the group; and
request the cellular communication system to secure the resource.
